(19) United States
(12) Patent Application Publication
(10) Pub. No.: US 2014/0140049 A1
(43) Pub. Date: May 22, 2014

(54) ELECTRONIC DEVICE CASE WITH ILLUMINATED MAGNIFIER

(71) Applicant: Manuel Cotelo, Tom's River, NJ (US)

(72) Inventor: Manuel Cotelo, Tom's River, NJ (US)

(21) Appl. No.: 13/679,904

(22) Filed: Nov. 16, 2012

(51) Int. Cl. F21L 4/02; F21L 4/00

(52) U.S. Cl. CPC F21L 4/02; F21L 4/00
USPC 362/184; 362/190

(57) ABSTRACT

An electronic device case has a magnifying glass that can extend from and be returned into one side of the case. The magnifying glass can be illuminated by a light emitting diode (LED) so that a person can read in any environment or lighting condition. The electronic device case can have its own integrated power source so as not to remove power from the electronic device. The electronic case can be designed as a slim profile case for various devices, such as smart phones, e-readers, tablets, and other similar devices.

### BACKGROUND OF THE INVENTION

The present invention relates to electronic device cases and, more particularly, to an electronic device case, such as a cell phone or smart phone case, that contains a magnifying glass with a built-in miniature light emitting diode (LED) that can retract from and be reinserted into the back of the case.

Many adults have difficulties reading small print, such as details on a menu in a dimly lit restaurant, package ingredients in a grocery store, or other such material.

Most people today carry cell phones with them wherever they go. As technology progresses, these phones, often called smart phones, can be programmed with applications that can perform various functions. One such application is a built-in magnification application that can magnify text, input via the phone's camera, and display the text, appropriately enlarged and illuminated, on the display screen.

This technology, however, requires the use of the electronic device, thus using valuable power from the phone and reducing the phone's talk and/or standby time.

Other solutions to solve the problem of reading small print include carrying a magnifying glass or other similar magnification device. This solution, however, requires the user to have a separate item when can be easily lost or forgotten.

As can be seen, there is a need for a magnification device that can be integrated with a user's mobile electronic device and provide magnification and illumination without draining the batter of the mobile electronic device.

### SUMMARY OF THE INVENTION

In one aspect of the present invention, a case for an electronic device comprises a case main body having a false bottom operable to support the electronic device; a power source disposed in the case; a magnifier unit operable between a first position, secured between the false bottom and a bottom portion of the case, and a second position, extending outward from a slot defined between the false bottom and the bottom portion; and a light operable to illuminate when the magnifier unit is disposed in the second position, the light powered by the power source.

In another aspect of the present invention, a case for an electronic device comprises a case main body having a false bottom operable to support the electronic device; at least one battery disposed in the case; a magnifier unit operable between a first position, secured between the false bottom and a bottom portion of the case, and a second position, extending outward from a slot defined between the false bottom and the bottom portion; at least one light emitting diode operable to illuminate when the magnifier unit is disposed in the second position, the light powered by the at least one battery; at least one spring operable to urge the magnifier unit in the second position; and a release button, the release button having a prong operable to engage a detent in the magnifier unit to retain the magnifier unit in the first position.

These and other features, aspects and advantages of the present invention will become better understood with reference to the following drawings, description and claims.

### BRIEF DESCRIPTION OF THE DRAWINGS

FIG. 1 is a perspective view of an electronic device case, in use with an electronic device, having an illuminated magnification device in a deployed configuration;

FIG. 2 is an exploded perspective view of the electronic device case of FIG. 1, with the illuminated magnification device in a stored configuration;

FIG. 3 is a cross-sectional view taken along line 3-3 of FIG. 2, with the illuminated magnification device in a deployed configuration;

FIG. 4 is a cross-sectional view taken along lien 3-3 of FIG. 2, with the illuminated magnification device in a stored configuration;

FIG. 5 is a detailed cross-sectional view taken along line 5-5 of FIG. 3; and

FIG. 6 is a detailed cross-sectional view taken along line 6-6 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electronic device case that has a magnifying glass that can extend from and be returned into one side of the case. The magnifying glass can be illuminated by a light emitting diode (LED) so that a person can read in any environment or lighting condition. The electronic device case can have its own integrated power source so as not to remove power from the electronic device. The electronic case can be designed as a slim profile case for various devices, such as smart phones, e-readers, tablets, and other similar devices.

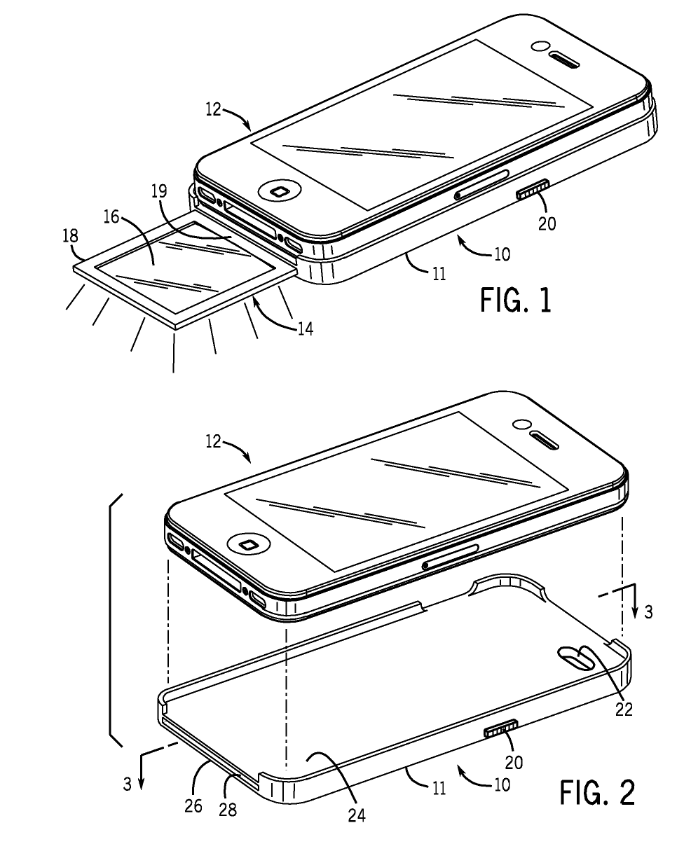

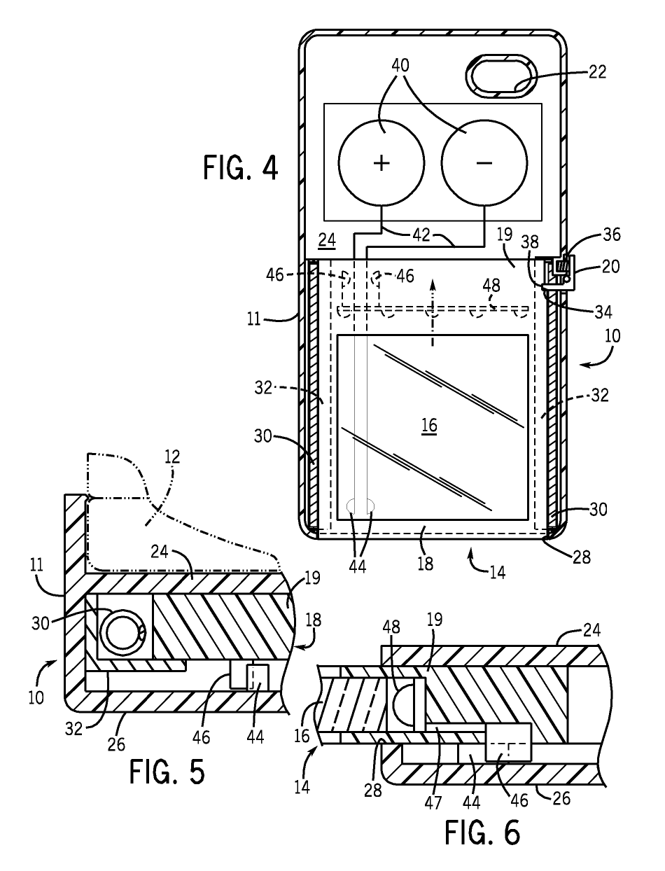

Referring now to FIGS. 1 through 5, a cell phone case 10 can be designed to hold and protect an electronic device, such as a smart phone 12. The cell phone case can be designed to permit the usual functions of the smart phone 12 by, for example, including a camera lens aperture 22 within the main body 11 of the cell phone case 10. The smart phone 12 can fit into the cell phone case 10, against a false bottom of the main body 11.

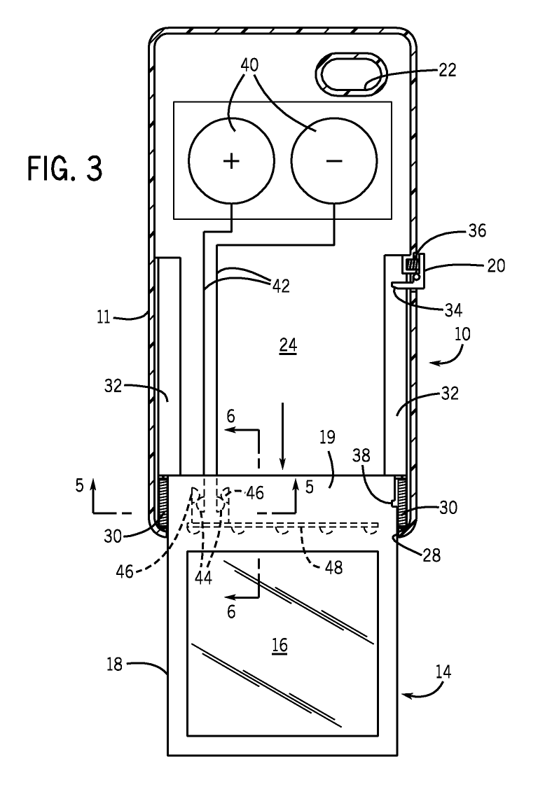

As shown in FIG. 1, a magnifier unit 14 can resiliently extend from a slot 28 formed in one side of the cell phone case 10, between the false bottom 24 and a bottom 26 of the main body 11. A button 20 can be disposed on one or more sides of the cell phone case 10 to release a catch (described below) and allow the magnifier unit 14 to extend from the slot 28. Typically, the slot 28 can be disposed on a top or bottom side of the cell phone case 10 and the button 20 can be disposed on one side of the cell phone case 10, as shown in FIG. 3, or may be disposed on both sides of the cell phone case 10, where both buttons 20, on each side, must be depressed to release the magnifier unit 14, thereby reducing the chance of accidental deployment. The button 20 can include a compression spring 36 to keep the button in an engaged position, where pressing the button 20 moves a prong 34 of the button 20 from engagement of a detent 38 in the distal end 19 of the magnifier unit 14.

The magnifier unit 14 can include a frame 18 surrounding a magnifier 16. A distal end 19 of the magnifier unit 14 can include a LED ribbon 48, as described in greater detail below.

Power can be provided to an LED ribbon 48 with one or more batteries 40. Typically, the batteries 40 can be button batteries designed to fit below the false bottom 24 of the body 11 adjacent to an area containing the magnifier unit 14 when in a stored position.

The power can be carried by conductors 42 from the batteries 40 to contacts 44 disposed in the cell phone case 10. When the magnifier unit 14 is extended from the slot 28 (by pushing the button 20), contacts 46 of the magnifier unit 14 can contact contacts 44 of the conductors 42 to electrically connect the contacts 44, 46. The contacts 46 of the magnifier unit 14 are electrically connected to the LED ribbon 48, thereby illuminating the LED ribbon when the magnifier unit 14 is extended from the slot 28.

The magnifier unit 14 can be extended out of the slot 28 through the force of springs 30. When the user wants to store the magnifier unit 14, they can press in the magnifier unit 14 against the force of the springs 30 to lock the detent 38 in the distal end 19 of the magnifier unit 14 into the prong 34 of the release button 20. Typically, a spring 30 can be disposed on each side of the magnifier unit 14. The spring 30 can be made of various materials, including plastic, composite or metal, such as aluminum or stainless steel.

The springs 30 can be disposed in a channel, adjacent the magnifier unit 14, defined at least partially by a guide rail 32. The guide rail 32 can be an L-shaped member that can support the frame 18 of the magnifier unit 14.

The cell phone case 10 can be custom molded to fit various styles and designs of electronic devices, such as smart phones, including the iPhone by Apple. The cell phone case 10 can be molded to a uniform thickness as dictated by the type of battery required to power the LED light. Typically, the LED ribbon 48 can be mounted on the bottom edge of the magnifier 16 and automatically turns on when the magnifier unit 14 is extended from the cell phone case 10.

The cell phone case 10 can be made from various conventional methods and from various materials. Typically, the cell phone case 10 can be fabricated by a mold facility based upon the design. Depending on the manufacture technique, various components can be molded integrally, or molded separately and connected together.

To use the cell phone case 10 of the present invention, a user can simply insert their electronic device, such as their smart phone 12, into the cell phone case 10 and use their smart phone 12 as usual, knowing that the case also helps protect their smart phone 12. When the user needs a magnifier, they can simply press a small button (release button 20) on the side of the cell phone case 10 to release the magnifier unit 14 from the slot 28. Under the force of the springs 30, the magnifier unit 14 will pop out of the slot 28 and fully extend to a use position. In addition, as the magnifier unit 14 is fully extended, electrical connections can be established to permit illumination of the LED lights (LED ribbon 48) disposed to illuminate an area being magnified through the magnifier 16 of the magnifier unit 14.

The magnifier unit 14 can be made in various sizes and shapes. Typically the magnifier unit 14 is rectangular or square. In some embodiments, the magnifier unit 14 can be made as a 2-inch by 2-inch square, however, if a larger electronic device is used with the cell phone case 10, larger magnifier units 14 may also be used.

While the above refers to the use of a cell phone case 10 adapted for use with a smart phone 12, the present invention can be applied to cases for various electronic devices, including not only smart phones, but also tablets, e-readers, or the like.

It should be understood, of course, that the foregoing relates to exemplary embodiments of the invention and that modifications may be made without departing from the spirit and scope of the invention as set forth in the following claims.

What is claimed is:

1. A case for an electronic device comprising:
a case main body having a false bottom operable to support the electronic device;
a power source disposed in the case;
a magnifier unit operable between a first position, secured between the false bottom and a bottom portion of the case, and a second position, extending outward from a slot defined between the false bottom and the bottom portion; and
a light operable to illuminate when the magnifier unit is disposed in the second position, the light powered by the power source.

2. The case of claim 1, wherein the power source includes one or more batteries.

3. The case of claim 1, wherein the light includes at least one light emitting diode.

4. The case of claim 3, wherein the light includes a light emitting diode ribbon.

5. The case of claim 1, wherein the magnifier unit includes a frame surrounding a magnifier.

6. The case of claim 1, further comprising at least one spring operable to urge the magnifier unit in the second position.

7. The case of claim 6, wherein the least one spring includes two springs on each side of the magnifier unit inside the case.

8. The case of claim 6, further comprising a release button, the release button having a prong operable to engage a detent in the magnifier unit to retain the magnifier unit in the first position.

9. The case of claim 1, further comprising guide rails disposed inside the slot, the guide rails providing a surface to support the magnifier unit as it moves between the first position and the second position.

10. The case of claim 1, further comprising:
conductor contacts disposed in the case, the conductor contacts connected to the power source via conductors; and
magnifier unit contacts disposed on the magnifier unit, wherein
the conductor contacts electrically connect with the magnifier unit contacts when the magnifier unit is in the second position.

11. A case for an electronic device comprising:
a case main body having a false bottom operable to support the electronic device;
at least one battery disposed in the case;
a magnifier unit operable between a first position, secured between the false bottom and a bottom portion of the case, and a second position, extending outward from a slot defined between the false bottom and the bottom portion;
at least one light emitting diode operable to illuminate when the magnifier unit is disposed in the second position, the light powered by the at least one battery;
at least one spring operable to urge the magnifier unit in the second position; and
a release button, the release button having a prong operable to engage a detent in the magnifier unit to retain the magnifier unit in the first position.

12. The case of claim 11, wherein the light includes a light emitting diode ribbon.

13. The case of claim 11, wherein the magnifier unit includes a frame surrounding a magnifier.

14. The case of claim 11, wherein the least one spring includes two springs on each side of the magnifier unit inside the case.

15. The case of claim 11, further comprising guide rails disposed inside the slot, the guide rails providing a surface to support the magnifier unit as it moves between the first position and the second position.

16. The case of claim 11, further comprising:
conductor contacts disposed in the case, the conductor contacts connected to the power source via conductors; and
magnifier unit contacts disposed on the magnifier unit, wherein
the conductor contacts electrically connect with the magnifier unit contacts when the magnifier unit is in the second position.
